(19) United States
(12) Patent Application Publication
(10) Pub. No.: US 2013/0214625 A1
(43) Pub. Date: Aug. 22, 2013

(54) VOLTAGE CONVERSION DEVICE FOR MOTOR

(71) Applicant: ZHONGSHAN BROAD-OCEAN MOTOR CO., LTD., (US)

(72) Inventor: Guangchang CHEN, Zhongshan (CN)

(73) Assignee: ZHONGSHAN BROAD-OCEAN MOTOR CO., LTD., Zhongshan (CN)

(21) Appl. No.: 13/845,050

(22) Filed: Mar. 17, 2013

Related U.S. Application Data
(63) Continuation-in-part of application No. PCT/CN2012/074787, filed on Apr. 27, 2012.

(30) Foreign Application Priority Data
Dec. 5, 2011 (CN) 201120500683.9

(51) Int. Cl. H02K 11/00

(52) U.S. Cl. CPC H02K 11/0094
USPC 310/71

(57) ABSTRACT

A voltage conversion device for a motor in combination with the motor. The motor includes a stator winding. The winding leads are led out from the stator winding. The conversion device includes a socket and a plug. Part of the winding leads are in electric connection with the socket. The rest of the winding leads is in electric connection with the plug. The plug is inserted into the socket for changing the connection between the polyphase windings.

### CROSS-REFERENCE TO RELATED APPLICATIONS

This application is a continuation-in-part of International Patent Application No. PCT/CN2012/074787 with an international filing date of Apr. 27, 2012, designating the United States, now pending, and further claims priority benefits to Chinese Patent Application No. 201120500683.9 filed Dec. 5, 2011. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a voltage conversion device for a motor.

2. Description of the Related Art

A typical voltage conversion method of a dual voltage motor is usually realized in a way as follows: leading out 4 leads from a motor winding, and then directly butting the leads. However, the method has the defects that: first, as the leads are directly butted, the operation is inconvenient, the reliability is low, and the potential safety hazard exists; second, when the motor voltage is required to be converted, the operation of exchanging leads is troublesome.

### SUMMARY OF THE INVENTION

In view of the above-described problems, it is one objective of the invention to provide a voltage conversion device for a motor. The device is simple in structure, secure and reliable and convenient and easy for voltage conversion operation.

To achieve the above objective, in accordance with one embodiment of the invention, there is provided a voltage conversion device for a motor, comprising: a motor comprising a stator winding, winding leads led out from the stator winding, and a conversion device. The conversion device comprises a socket and a plug. Part of the winding leads are in electric connection with the socket. The rest winding leads are in electric connection with the plug. The plug is inserted into the socket for changing the connection between polyphase windings.

In a class of this embodiment, the socket comprises a plurality of jacks. Terminal sleeves are installed inside the jacks. Part of the winding leads are in electric connection with the terminal sleeves. The plug comprises a plurality of contact pins. The rest winding leads are in electric connection with the contact pins, and the contact pins are embedded in the terminal sleeves.

In a class of this embodiment, an annular lug boss is raised from an edge at an end part of the socket. A notch is formed on the annular lug boss. A step is arranged at an end part of the plug. A lug is raised from the step. The annular lug boss is supported on the step. The lug is embedded in the notch.

In a class of this embodiment, the motor is a single-phase motor and comprises a main stator winding in two turns, and the winding leads are led out from two ends of the main stator winding, and comprise winding leads A1, A2, B1, B2, C1, and C2.

In a class of this embodiment, the number of the jacks is equal to that of the contact pins, and the positions of the jacks correspond to those of the contact pins.

In a class of this embodiment, the jacks comprise a first jack, a second jack, and a third jack. The contact pins comprise a first contact pin, a second contact pin, and a third contact pin. The winding lead A1 is in electric connection with a terminal sleeve of the first jack, the winding lead A2 is in electric connection with a terminal sleeve of the second jack, the winding lead B1 is in electric connection with a first contact pin, the winding lead B2 is in electric connection with a second contact pin, and the winding lead C1 and the winding lead C2 are connected with a power supply.

Advantages of the invention are summarized as follows:

(1) the conversion device comprises a socket and a plug, part of winding leads are in electric connection with the socket, the rest winding leads are in electric connection with the plug, and the plug is inserted into the socket for changing the connection of polyphase windings, thus the conversion device is simple in structure, secure and reliable and convenient and easy for voltage conversion operation;

(2) the socket comprises a plurality of jacks, terminal sleeves are installed inside the jacks, part of the winding leads are in electric connection with the terminal sleeves, the plug comprises a plurality of contact pins, the rest winding leads are in electric connection with the contact pins, and the contact pins are embedded in the terminal sleeves, thus the design is reasonable, and the installation is firm;

(3) an annular lug boss is raised from the edge at the end part of the socket, a notch is formed on the annular lug boss, a step is arranged at the end part of the plug, a lug is raised from the step, the annular lug boss is supported on the step, and the lug is embedded in the notch, thus the structural design is reasonable, the installation is convenient, the lug is matched with the notch to prevent the winding lead A1 and the winding lead B2 from being connected directly to lead to a short circuit of the motor, therefore, the motor is protected effectively.

### BRIEF DESCRIPTION OF THE DRAWINGS

FIG. 1 is a three-dimensional diagram of a voltage conversion device for a motor of the invention;

FIG. 2 is a three-dimensional diagram of a conversion device of the invention;

FIG. 3 is a three-dimensional diagram of a conversion device of the invention from another angle;

FIG. 4 is a structural diagram of a voltage conversion device for a motor of Example 1 of the invention;

FIG. 5 is a sectional view taken from line A-A of FIG. 4;

FIG. 6 is a sectional view taken from line B-B of FIG. 4;

FIG. 7 is a diagram for connection between windings in Example 1;

FIG. 8 is a structural diagram of a voltage conversion device for a motor of Example 2 of the invention;

FIG. 9 is a sectional view taken from line C-C of FIG. 8;

FIG. 10 is a sectional view taken from line D-D of FIG. 8; and

FIG. 11 is a diagram for connection between windings in Example 2.

### DETAILED DESCRIPTION OF THE EMBODIMENTS

For further illustrating the invention, experiments detailing a voltage conversion device for a motor are described below. It should be noted that the following examples are intended to describe and not to limit the invention.

### EXAMPLE 1

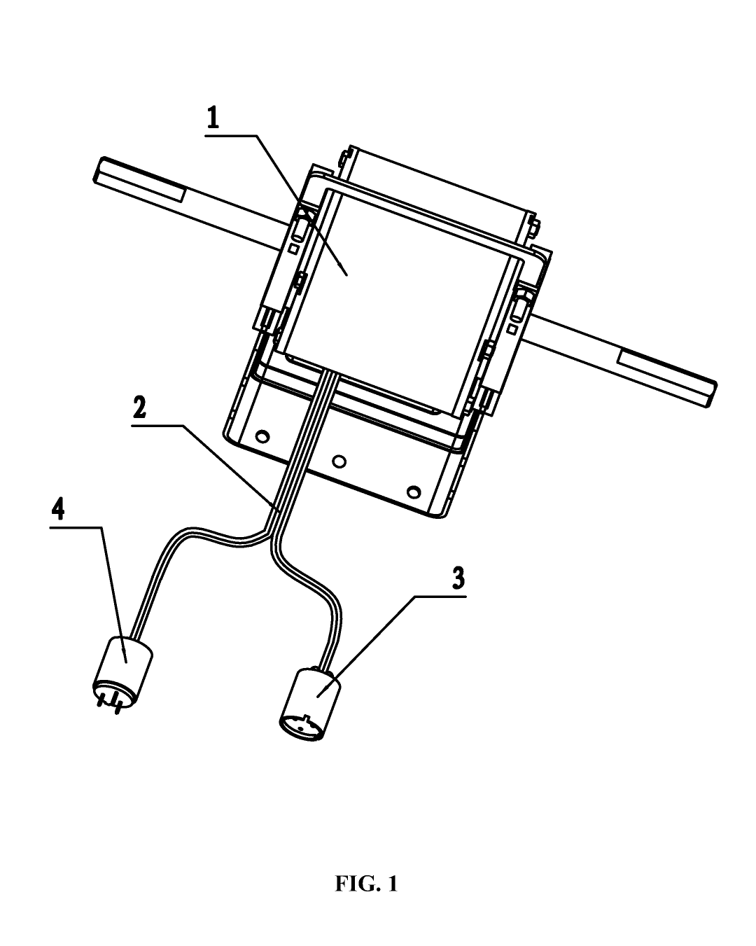

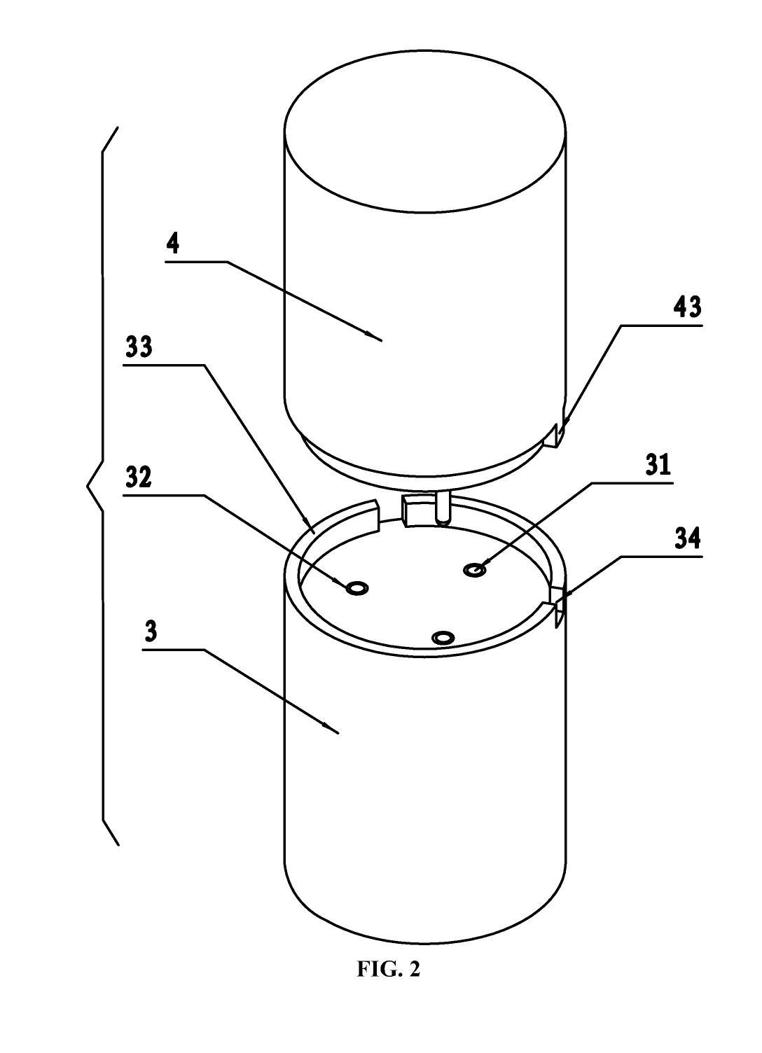

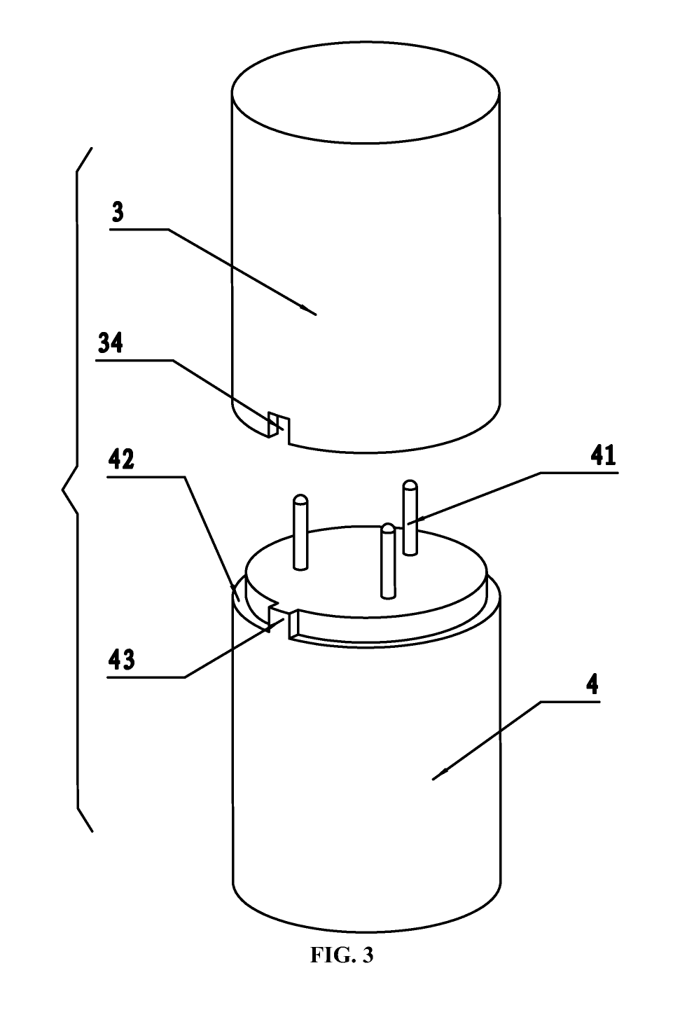

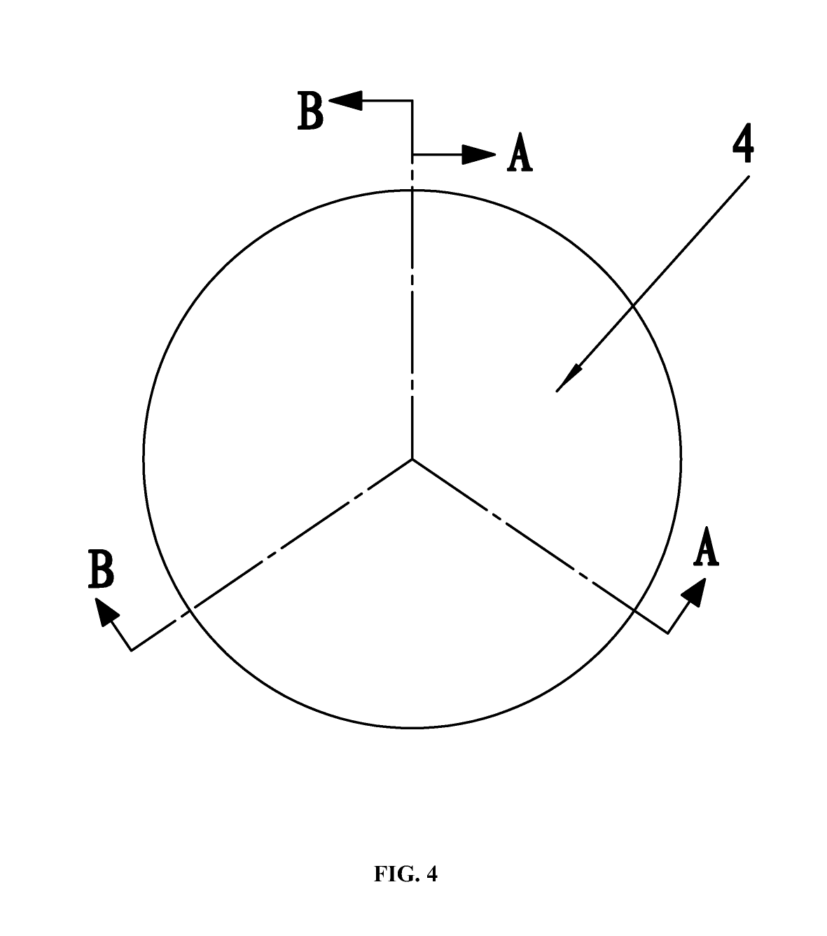

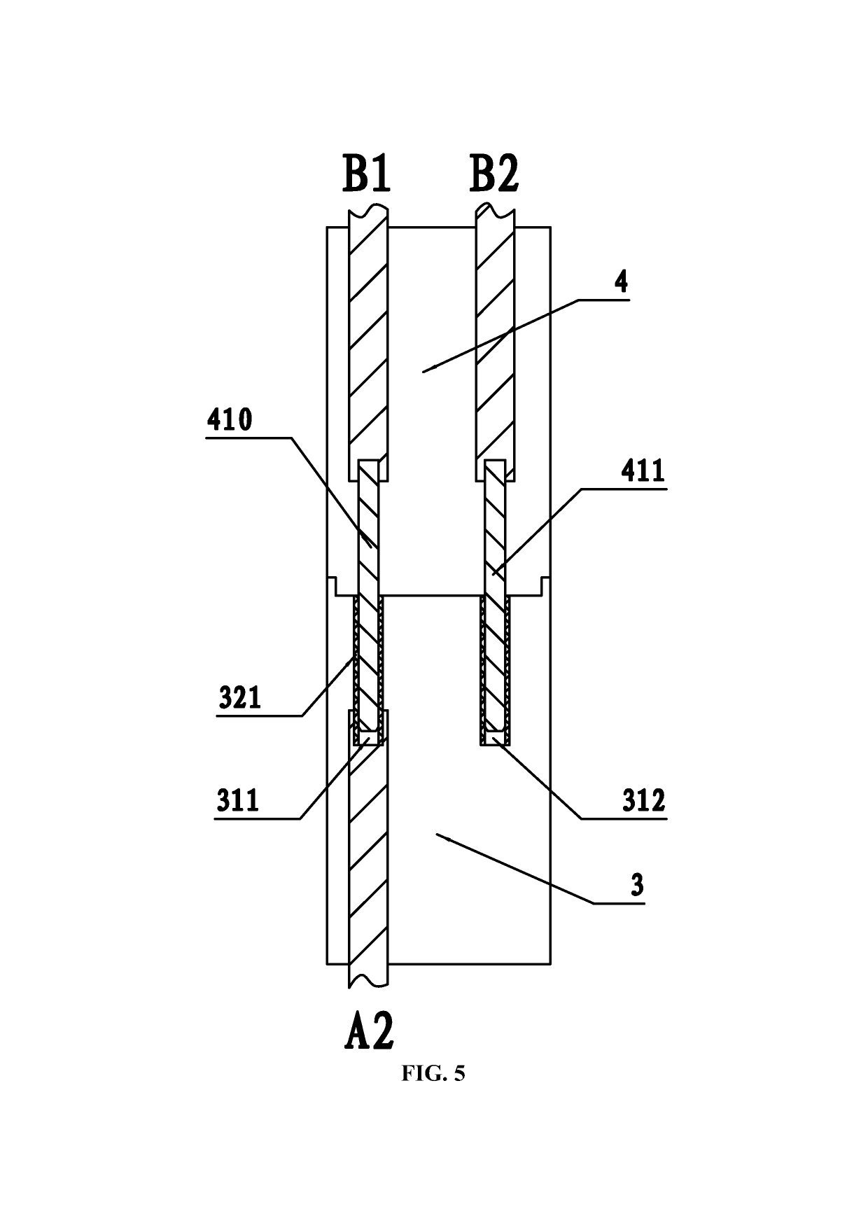

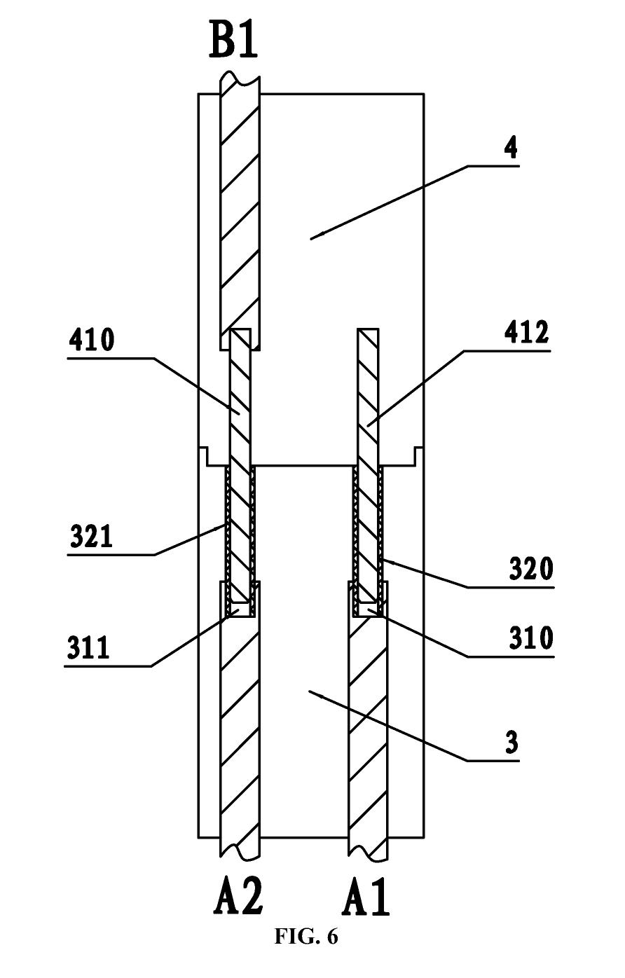

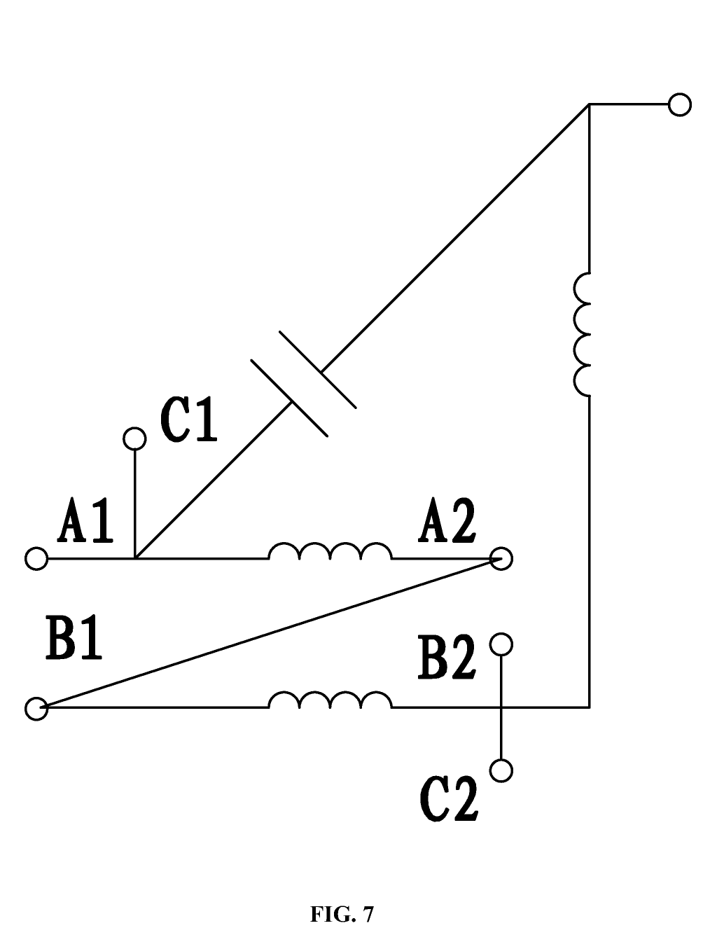

As shown in FIGS. 1-7, a voltage conversion device for a motor comprises a motor 1, winding leads 2 led out from a stator winding of the motor 1, and a conversion device. The conversion device comprises a socket 3 and a plug 4. Part of the winding leads are in electric connection with the socket 3. The rest winding leads 2 are in electric connection with the plug 4, and the plug 4 is inserted into the socket 3 for changing the connection between polyphase windings. The socket 3 comprises a plurality of jacks 31, terminal sleeves 32 are installed inside the jacks 31, part of the winding leads 2 are in electric connection with the terminal sleeves 32. The plug 4 comprises a plurality of contact pins 41, the rest winding leads 2 are in electric connection with the contact pins 41, and the contact pins 41 are embedded in the terminal sleeves 32. An annular lug boss 33 is raised from the edge at the end part of the socket 3. A notch 34 is formed on the annular lug boss 33. A step 42 is arranged at the end part of the plug 4. A lug 43 is raised from the step 42. The annular lug boss 33 is supported on the step 42, and the lug 43 is embedded in the notch 34. The motor 1 is a single-phase motor and comprises a main stator winding in two turns, and the winding leads 2 are led out from two ends of the main stator winding, and comprise winding leads A1, A2, B1, B2, C1 and C2. The number of the jacks 31 is equal to that of the contact pins 41, and the positions of the jacks 31 correspond to those of the contact pins 41. The jacks 31 comprise a first jack 310, a second jack 311 and a third jack 312. The contact pins 41 comprise a first contact pin 410, a second contact pin 411 and a third contact pin 412. The winding lead A1 is in electric connection with the terminal sleeve 320 of the first jack 310. The winding lead A2 is in electric connection with the terminal sleeve 321 of the second jack 311. The winding lead B1 is in electric connection with the first contact pin 410. The winding lead B2 is in electric connection with the second contact pin 411, and the winding lead C1 and the winding lead C2 are connected with a power supply.

When the first contact pin 410 is connected with the terminal sleeve 321 of the second jack 311, the second contact pin 411 is connected with the third jack 312, and the third contact pin 412 is connected with the terminal sleeve 320 of the first jack 310, that is, the winding lead A2 is connected with the winding lead B1, windings are connected in series, and high voltage is used.

### EXAMPLE 2

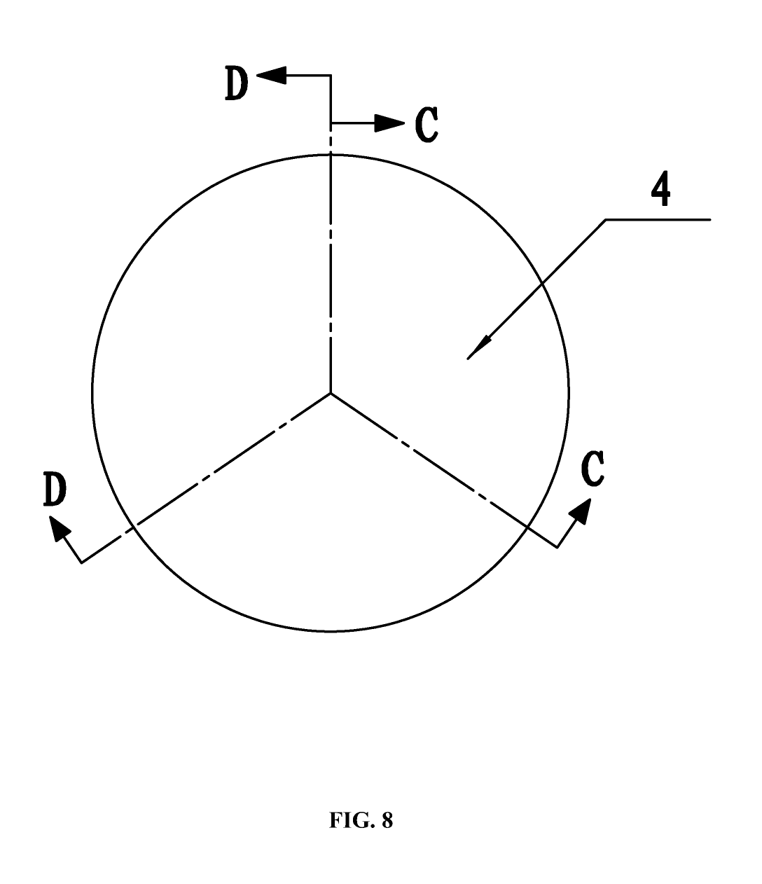

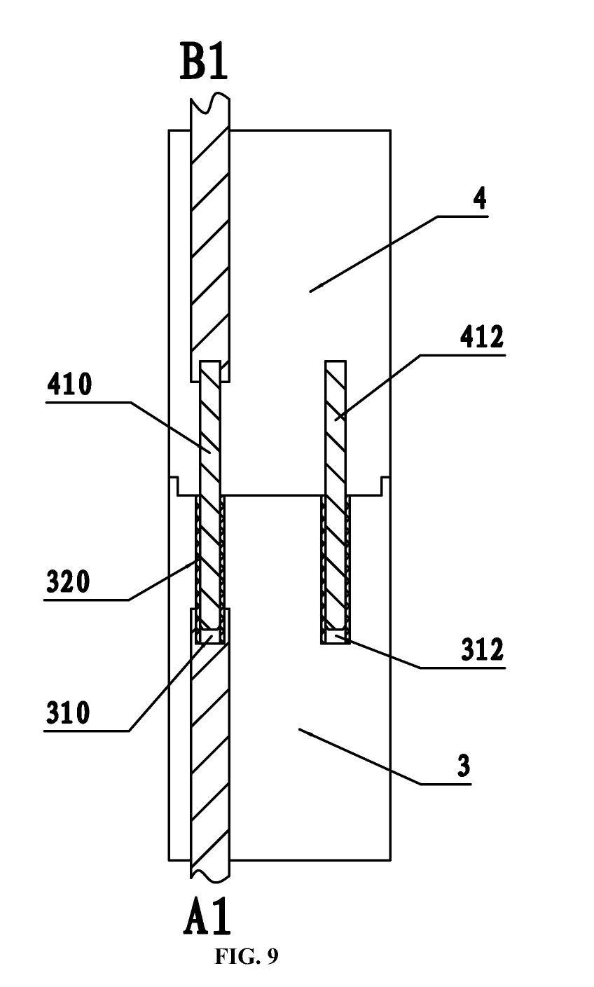

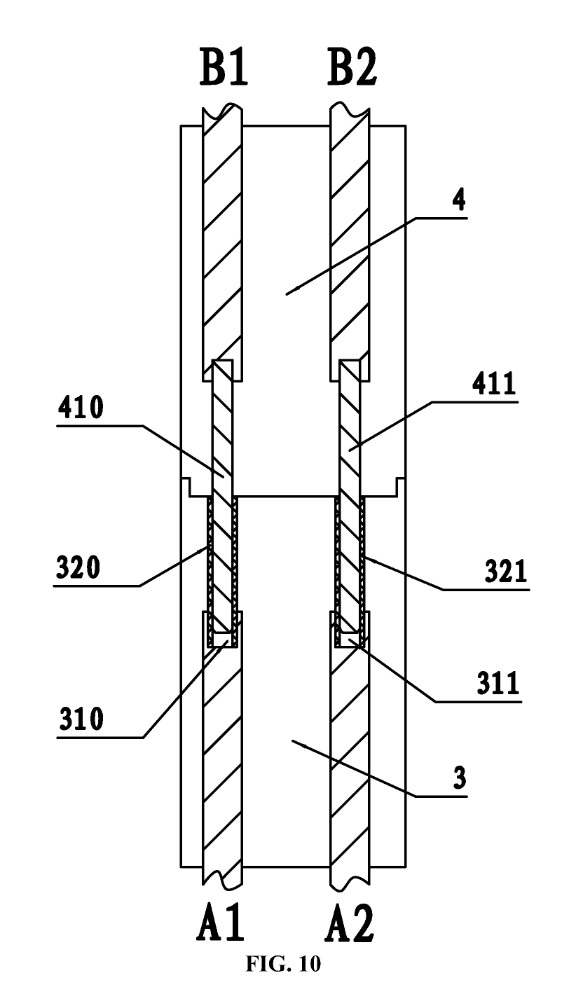

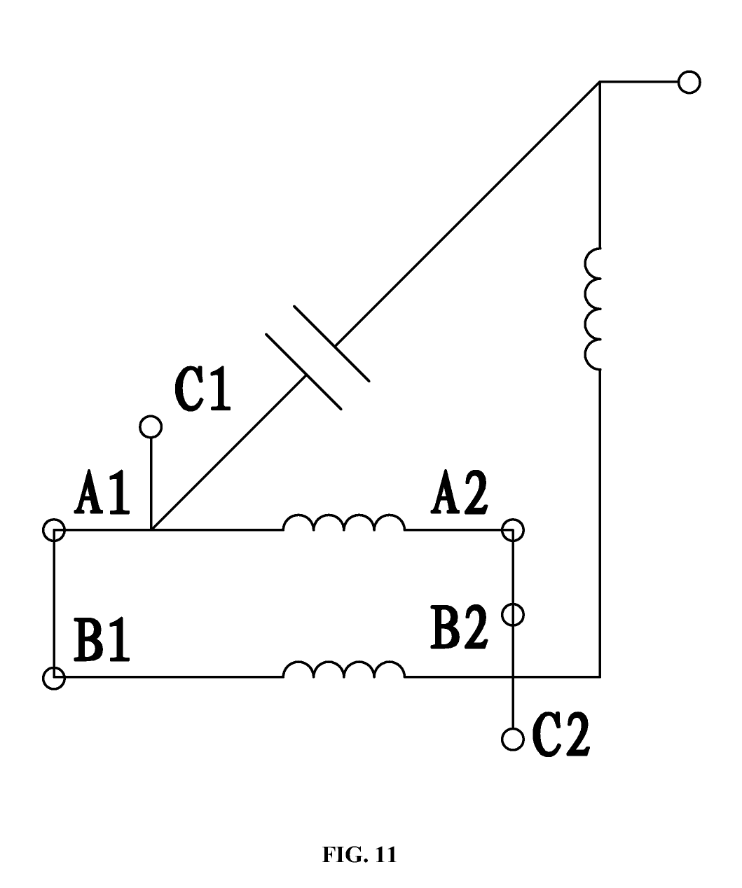

As shown in FIGS. 1-3 and 8-11, a voltage conversion device for a motor comprises a motor 1, winding leads 2 led out from a stator winding of the motor 1, and a conversion device. The conversion device comprises a socket 3 and a plug 4. Part of the winding leads are in electric connection with the socket 3. The rest winding leads 2 are in electric connection with the plug 4, and the plug 4 is inserted into the socket 3 for changing the connection between polyphase windings. The socket 3 comprises a plurality of jacks 31, terminal sleeves 32 are installed inside the jacks 31, part of the winding leads 2 are in electric connection with the terminal sleeves 32. The plug 4 comprises a plurality of contact pins 41, the rest winding leads 2 are in electric connection with the contact pins 41, and the contact pins 41 are embedded in the terminal sleeves 32. An annular lug boss 33 is raised from the edge at the end part of the socket 3. A notch 34 is formed on the annular lug boss 33. A step 42 is arranged at the end part of the plug 4. A lug 43 is raised from the step 42. The annular lug boss 33 is supported on the step 42, and the lug 43 is embedded in the notch 34. The motor 1 is a single-phase motor and comprises a main stator winding in two turns, and the winding leads 2 are led out from two ends of the main stator winding, and comprise winding leads A1, A2, B1, B2, C1 and C2. The number of the jacks 31 is equal to that of the contact pins 41, and the positions of the jacks 31 correspond to those of the contact pins 41. The jacks 31 comprise a first jack 310, a second jack 311 and a third jack 312. The contact pins 41 comprise a first contact pin 410, a second contact pin 411 and a third contact pin 412. The winding lead A1 is in electric connection with the terminal sleeve 320 of the first jack 310. The winding lead A2 is in electric connection with the terminal sleeve 321 of the second jack 311. The winding lead B1 is in electric connection with the first contact pin 410. The winding lead B2 is in electric connection with the second contact pin 411, and the winding lead C1 and the winding lead C2 are connected with a power supply.

When the first contact pin 410 is connected with the terminal sleeve 320 of the first jack 310, the second contact pin 411 is connected with the terminal sleeve 321 of the second jack 311, and the third contact pin 412 is connected with the third jack 312, that is, the winding lead A1 is connected with the winding lead B1, the winding lead A2 is connected with the winding lead B2, windings are connected in parallel, and low voltage is used.

The invention claimed is:

1. An apparatus comprising:
a) a motor (1), the motor comprising a stator winding;
b) winding leads (2), the winding leads (2) being led out from the stator winding; and
c) a conversion device;
wherein
the conversion device comprises a socket (3) and a plug (4);
part of the winding leads are in electric connection with the socket (3), and the rest winding leads (2) are in electric connection with the plug (4), and
the plug (4) is inserted into the socket (3) for changing the connection between polyphase windings.

2. The apparatus of claim 1, wherein
the socket (3) comprises a plurality of jacks (31);
terminal sleeves (32) are installed inside the jacks (31);
part of the winding leads (2) are in electric connection with the terminal sleeves (32);
the plug (4) comprises a plurality of contact pins (41);
the rest winding leads (2) are in electric connection with the contact pins (41); and
the contact pins (41) are embedded in the terminal sleeves (32).

3. The apparatus of claim 1, wherein
an annular lug boss (33) is raised from an edge at an end part of the socket (3);
a notch (34) is formed on the annular lug boss (33);
a step (42) is arranged at an end part of the plug (4);
a lug (43) is raised from the step (42);
the annular lug boss (33) is supported on the step (42); and
the lug (43) is embedded in the notch (34).

4. The apparatus of claim 2, wherein
an annular lug boss (33) is raised from an edge at an end part of the socket (3);
a notch (34) is formed on the annular lug boss (33);
a step (42) is arranged at an end part of the plug (4);
a lug (43) is raised from the step (42);
the annular lug boss (33) is supported on the step (42); and
the lug (43) is embedded in the notch (34).

5. The apparatus of claim 3, wherein
the motor (1) is a single-phase motor and comprises a main stator winding in two turns; and
the winding leads (2) are led out from two ends of the main stator winding, and comprise winding leads A1, A2, B1, B2, C1, and C2.

6. The apparatus of claim 4, wherein
the motor (1) is a single-phase motor and comprises a main stator winding in two turns; and
the winding leads (2) are led out from two ends of the main stator winding, and comprise winding leads A1, A2, B1, B2, C1, and C2.

7. The apparatus of claim 5, wherein the number of the jacks (31) is equal to that of the contact pins (41), and the positions of the jacks (31) correspond to those of the contact pins (41).

8. The apparatus of claim 6, wherein the number of the jacks (31) is equal to that of the contact pins (41), and the positions of the jacks (31) correspond to those of the contact pins (41).

9. The apparatus of claim 7, wherein
the jacks (31) comprise a first jack (310), a second jack (311), and a third jack (312);
the contact pins (41) comprise a first contact pin (410), a second contact pin (411), and a third contact pin (412);
the winding lead A1 is in electric connection with a terminal sleeve (320) of the first jack (310);
the winding lead A2 is in electric connection with a terminal sleeve (321) of the second jack (311);
the winding lead B1 is in electric connection with a first contact pin (410);
the winding lead B2 is in electric connection with a second contact pin (411); and
the winding lead C1 and the winding lead C2 are connected with a power supply.

10. The apparatus of claim 8, wherein
the jacks (31) comprise a first jack (310), a second jack (311), and a third jack (312);
the contact pins (41) comprise a first contact pin (410), a second contact pin (411), and a third contact pin (412);
the winding lead A1 is in electric connection with a terminal sleeve (320) of the first jack (310);
the winding lead A2 is in electric connection with a terminal sleeve (321) of the second jack (311);
the winding lead B1 is in electric connection with a first contact pin (410);
the winding lead B2 is in electric connection with a second contact pin (411); and
the winding lead C1 and the winding lead C2 are connected with a power supply.
